(19) United States
(12) Patent Application Publication
(10) Pub. No.: US 2004/0051460 A1
(43) Pub. Date: Mar. 18, 2004

(54) Discharge bulb

(75) Inventors: Masaya Shido, Shizuoka (JP); Masayuki Umehara, Shizuoka (JP); Shinichi Irisawa, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: KOITO MANUFACTURING CO., LTD.

(21) Appl. No.: 10/617,870

(22) Filed: Jul. 14, 2003

(30) Foreign Application Priority Data
Jul. 25, 2002 (JP) P. 2002-217347

(51) Int. Cl. H01J 17/20

(52) U.S. Cl. 313/638

(57) ABSTRACT

A discharge bulb including an arc tube 16 having a light-emitting tube portion 20a and shroud glass 18 surrounding the arc tube 16 in a tubular form. An inert gas and metal halides are sealed in a discharge space 24 inside the light-emitting tube portion 20a, which is mercury-free. Xenon gas is filled in an annular space 34 between the arc tube 16 and the shroud glass 18. Heat is restrained from being transmitted from the light-emitting tube portion 20a to the shroud glass 18 through the annular space 34. An increase in the heat loss and the temperature rise of the shroud glass 18 are restrained.

### BACKGROUND OF THE INVENTION

1. Field of the Invention

This invention relates to a discharge bulb for use in a headlamp for a vehicle or the like.

2. Related Art

As disclosed in, for example, JP-A-6-20645, a discharge bulb for use in a headlamp typically includes an arc tube having a light-emitting tube portion and shroud glass surrounding this arc tube. Air (or nitrogen) is filled in an annular space between the arc tube and the shroud glass.

In addition, in the discharge bulb, mercury, together with an inert gas and metal halides, is generally sealed in the discharge space of the light-emitting tube portion of the arc tube so as to increase the luminous efficiency, as is also described in the above-described publication. In recent years, however, there has been a heightened social need for reducing the use of mercury, which is an environmentally harmful substance.

However, if a discharge bulb that does not use mercury, i.e., a so-called mercury-free discharge bulb, is adopted, the following problems are encountered.

Namely, although mercury is converted to mercury vapor upon the lighting up of the discharge bulb, it is possible to obtain high vapor pressure even at a low temperature in comparison with other metals. Therefore, mercury acts as a thermal buffer with respect to the tube wall of the light-emitting tube portion in the surroundings of the arc source. However, in the mercury-free discharge bulb, since the thermal buffer action is lost, the temperature of the tube wall of the light-emitting tube undesirably becomes high. Then, since the heat of this light-emitting tube portion is disadvantageously transmitted to the shroud glass through the annular space, the heat loss becomes large correspondingly. Hence, there is a problem in that the luminous efficiency of the arc source declines.

In addition, since the temperature of the shroud glass rises due to the heat transfer from the light-emitting tube portion, there is another problem in that silicon gas or the like in the lighting apparatus becomes attached to the surface of the shroud glass and becomes whitened.

### SUMMARY OF THE INVENTION

The invention of this application has been devised in view of the above-described circumstances, and one of its objects is to provide a discharge bulb which, even in a case where the discharge bulb is made mercury-free, makes it possible to restrain a decline in the luminous efficiency of the arc source and the whitening of the surface of the shroud glass.

This invention aims to attain the above object by devising a countermeasure in the composition of the gas that is filled in the annular space between the arc tube and the shroud glass.

Namely, the discharge bulb in accordance with this invention includes a discharge bulb including an arc tube having a light-emitting tube portion and shroud glass surrounding the arc tube in a tubular form, wherein

an inert gas and a metal halide are sealed in a discharge space inside the light-emitting tube portion, mercury not being sealed therein, and wherein

a gas containing not less than 50% in total of one or more of argon gas, krypton gas, and xenon gas is filled in an annular space between the arc tube and the shroud glass.

The above phrase “containing not less than 50% in total of one or more of argon gas, krypton gas, and xenon gas” is a concept which includes both a form in which one of argon gas, krypton gas, and xenon gas is contained as a simple substance gas by not less than 50% and a form in which a mixed gas composed of two or three kinds of gas selected from among argon gas, krypton gas, and xenon gas is contained by not less than 50%.

Of the “gas” filled in the aforementioned annular space, the kinds of gas other than argon gas, krypton gas, and xenon gas are not particularly limited.

As shown in the above-described construction, the discharge bulb in accordance with the present invention is formed as a mercury-free discharge bulb which includes the arc tube having the light-emitting tube portion and the shroud glass surrounding it in a tubular form. However, since a gas containing not less than 50% in total of one or more of argon gas, krypton gas, and xenon gas is filled in the annular space between the arc tube and the shroud glass, it is possible to obtain the following action and effects.

Namely, each of argon gas, krypton gas, and xenon gas is a gas whose thermal conductivity is substantially lower than air and nitrogen. Therefore, by providing a construction in which a gas containing not less than 50% in total of one or more of argon gas, krypton gas, and xenon gas is filled in the annular space, it becomes readily possible to substantially lower the thermal conductivity of the annular space in comparison with the conventional case where air (or nitrogen) is filled in the annular space.

For this reason, also in the case where the mercury-free discharge bulb is adopted in which the tube wall temperature of the light-emitting tube portion becomes high, it becomes possible to restrain the heat from being transmitted from the light-emitting tube portion to the shroud glass through the annular space. Consequently, it becomes possible to restrain a decline in the luminous efficiency of the arc source as a result of a large heat loss as in the conventional case. In addition, it is possible to restrain the temperature rise of the shroud glass and the whitening of its surface.

Thus, in accordance with this invention, even in the case where the discharge bulb is made mercury-free, it is possible to restrain a decline in the luminous efficiency of the arc source and the whitening of the surface of the shroud glass.

From the viewpoint of lowering the thermal conductivity of the annular space, it is conceivable to evacuate the annular space. In such a case, however, metal atoms (particularly sodium atoms) constituting metal halides sealed in the discharge space of the light-emitting tube portion are likely to pass through the light-emitting tube portion and to be removed from the discharge space. Consequently, the life performance characteristic (luminous flux maintenance factor) of the discharge bulb deteriorates, and chromaticity changes, so that this countermeasure is not preferable.

Incidentally, when an inert gas is included in the annular space, it is possible to expect an effect of an auxiliary discharge due to the gas in the shroud glass (i.e., the effect that the starting voltage of the discharge bulb can be lowered by ultraviolet rays produced by the discharge in the annular space between the arc tube and the shroud glass prior to the starting of the discharge in the light-emitting tube portion). Accordingly, since a gas containing not less than 50% in total of one or more of argon gas, krypton gas, and xenon gas, which are inert gases, is filled in the annular space, it is also possible to expect the effect of lowering the starting voltage of the discharge bulb.

As described above, each of argon gas, krypton gas, and xenon gas is a gas whose thermal conductivity is substantially low in comparison with air and nitrogen. However, since xenon gas is particularly low in thermal conductivity, it is particularly effective to use a gas containing not less than 60% xenon gas as the gas to be filled in the annular space.

In addition, in general, the thermal conductivity of gas is practically irrelevant to the pressure of that gas. Accordingly, the thermal conductivity of the annular space is also practically irrelevant to the charging pressure of that gas in the annular space. Hence, if this charging pressure is set to 0.2 to 0.9 atm, it is possible to obtain the following action and effects. Namely, by setting the charging pressure to a negative pressure of not more than 0.9 atm, the sealing of the shroud glass with respect to the arc tube can be easily effected by shrink sealing or the like. On the other hand, by setting the charging pressure to not less than 0.2 atm, sodium atoms sealed in the discharge space are restrained from passing through the light-emitting tube portion and being removed from the discharge space.

### BRIEF DESCRIPTION OF THE DRAWINGS

FIG. 1 is a side cross-sectional view illustrating a discharge bulb in accordance with an embodiment of the invention of this application; and

FIG. 2 is an enlarged view of a portion II of FIG. 1.

### DETAILED DESCRIPTION OF THE PREFERRED EMBODIMENTS

Referring now to the drawings, a detailed description will be given of a preferred embodiment of the present invention.

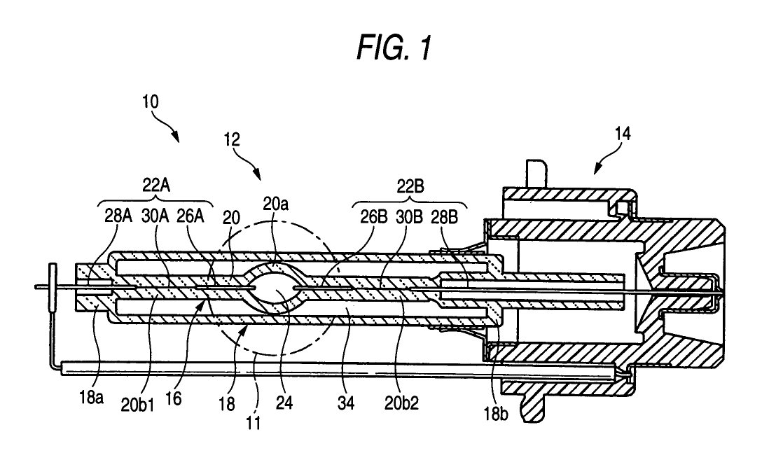

FIG. 1 is a side cross-sectional view illustrating a discharge bulb 10 in accordance with an embodiment of the invention of this application.

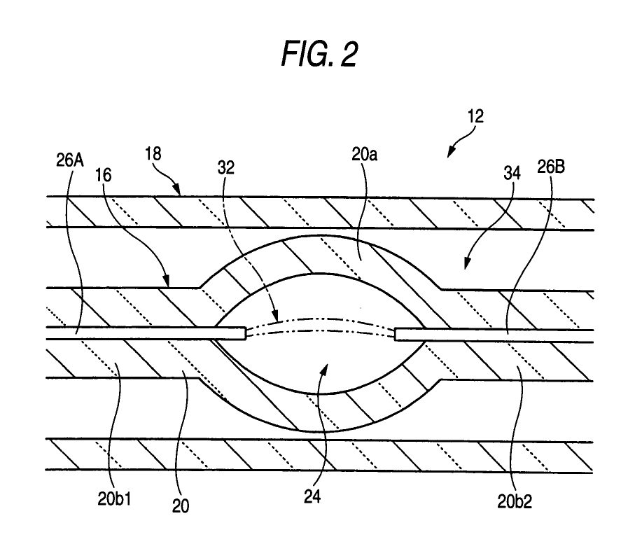

FIG. 2 is an enlarged view of a portion II of FIG. 1.

As shown in these drawings, this discharge bulb 10 is a light source bulb which is installed in a headlamp for a vehicle, and is comprised of an arc tube unit 12 extending in the longitudinal direction and an insulating plug unit 14 for fixing and supporting a rear-end portion of this arc tube unit 12.

The arc tube unit 12 is constructed such that an arc tube 16 and shroud glass 18 surrounding this arc tube 16 in an annular form (hollow cylindrical form) are formed integrally.

The arc tube 16 includes an arc tube body 20 formed by processing an elongated cylindrical quartz glass tube as well as a longitudinal pair of electrode assemblies 22A and 22B embedded in this arc tube body 20.

In the arc tube body 20, a substantially ellipsoidal light-emitting tube portion 20a is formed in its center, and pinch seal portions 20b1 and 20b2 are formed on both longitudinal sides thereof. A substantially ellipsoidal discharge space 24 extending in the longitudinal direction is formed inside the light-emitting tube portion 20a.

The electrode assemblies 22A and 22B are constructed such that rod-shaped electrodes 26A and 26B made of tungsten and lead wires 28A and 28B made of molybdenum are respectively connected and fixed through metal foils 30A and 30B made of molybdenum, and are pinch-sealed to the arc tube body 20 in the respective pinch seal portions 20b1 and 20b2. At that juncture, all the metal foils 30A and 30B are embedded in the pinch seal portions 20b1 and 20b2, but distal end portions of the rod-shaped electrodes 26A and 26B project from their front and rear sides into the discharge space 24 in such a manner as to oppose each other. Consequently, when the discharge bulb 10 is lit up, an arc source (discharge light-emitting portion) 32 is formed between the distal end portions of both rod-shaped electrodes 26A and 26B.

The discharge bulb 10 in accordance with this embodiment is formed as a mercury-free discharge bulb.

Namely, an inert gas and metal halides are sealed in the discharge space 24, but mercury is not sealed therein.

At that juncture, the inert gas is sealed in for the purpose of facilitating the generation of a discharge between the distal end portions of both rod-shaped electrodes 26A and 26B, and xenon gas is used in this embodiment. In addition, the metal halides are sealed in to enhance the luminous efficiency and the color rendering characteristic, and sodium iodide and scandium iodide are used in this embodiment.

It should be noted that mercury has a buffer function for alleviating damage to the rod-shaped electrode 26A (or 26B) by reducing the amount of impingement of electrons against the rod-shaped electrode 26A (or 26B). However, since the discharge bulb is made mercury-free, it becomes impossible to obtain this function. Accordingly, in this embodiment, a buffering metal halide is sealed in as a substitute of mercury for achieving the aforementioned buffer function. As this buffering metal halide, it is possible to use one kind or a plurality of kinds among halides of, for instance, Al, Bi, Cr, Cs, Fe, Ga, In, Li, Mg, Ni, Nd, Sb, Sn, Ti, Tb, and Zn.

The xenon gas is filled in an annular space 34 between the arc tube 16 and the shroud glass 18 in the arc tube unit 12. The charging pressure of this xenon gas is set to a negative pressure of 0.2 to 0.9 atm (e.g., 0.5 atm or thereabouts).

The sealing of the shroud glass 18 with respect to the arc tube 16 is effected as follows: After welding a rear end portion 18b of the shroud glass 18 to the arc tube 16, the xenon gas is filled in the annular space 34, and a front end portion 18a of the shroud glass 18 is subsequently welded to the arc tube 16. At that juncture, the welding of front end portion 18a of the shroud glass 18 to the arc tube 16 is effected, for example, by shrink sealing.

Next, a description will be given of the action and effects of this embodiment.

The discharge bulb 10 in accordance with this embodiment is formed as a mercury-free discharge bulb which includes the arc tube 16 having the light-emitting tube portion 20a and the shroud glass 18 surrounding it in a tubular form. However, since xenon gas is filled in the annular space 34 between the arc tube 16 and the shroud glass 18, it is possible to obtain the following action and effects.

Namely, in the state in which the discharge bulb 10 is lit, the temperature of the annular space 34 becomes 800° C. or thereabouts. At this 800° C., the thermal conductivity of air is approximately 0.066 (W/m·K), and the thermal conductivity of nitrogen is approximately 0.064 (W/m·K). On the other hand, the thermal conductivity of the xenon gas is approximately 0.016 (W/m·K), which is a substantially low value as compared with air and nitrogen. Accordingly, by filling this xenon gas in the annular space 34, it becomes possible to substantially lower the thermal conductivity of the annular space 34 as compared with the conventional case where air (or nitrogen) is filled in the annular space 34.

For this reason, and notwithstanding the fact that the tube wall temperature of the light-emitting tube portion 20a becomes high, it becomes possible to restrain the heat from being transmitted from the light-emitting tube portion 20a to the shroud glass 18 through the annular space 34. Consequently, it becomes possible to restrain a decline in the luminous efficiency of the arc source 32 due to the fact that the heat loss becomes large as in the conventional case. In addition, it is possible to restrain the temperature rise of the shroud glass 18 and the whitening of its surface.

As described above, according to this embodiment, even in the case where the discharge bulb 10 is made mercury-free, it is possible to restrain a decline in the luminous efficiency of the arc source 32 and the whitening of the surface of the shroud glass 18.

In addition, in this embodiment, since the xenon gas, which is an inert gas, is filled in the annular space 34, it is possible to expect the effect of lowering the starting voltage of the discharge bulb 10 by virtue of an auxiliary discharge.

Further, in this embodiment, since the charging pressure of the xenon gas in the annular space 34 is set to a negative pressure of 0.2 to 0.9 atm, sodium atoms of sodium iodide are restrained from passing through the light-emitting tube portion 20a and being removed from the discharge space 24. Additionally, the sealing of the shroud glass 18 with respect to the arc tube 16 can be easily effected by shrink sealing.

Incidentally, although it has been described in the foregoing embodiment that the xenon gas is filled in the annular space 34 as a simple substance gas, the thermal conductivity can be substantially lowered in comparison with air and nitrogen in cases where, instead of the xenon gas, argon gas (whose thermal conductivity at 800° C. is approximately 0.044 (W/m·K)) or krypton gas (whose thermal conductivity at 800° C. is approximately 0.025 (W/m·K)) is filled as the simple substance gas. Therefore, it is possible to obtain action and effects similar to those of the above-described embodiment.

In addition, the thermal conductivity can be substantially lowered in comparison with air and nitrogen also in cases in which the xenon gas and the argon gas are mixed at an arbitrary ratio, the xenon gas and the krypton gas are mixed at an arbitrary ratio, or the argon gas and the krypton gas are mixed at an arbitrary ratio, and the mixtures are filled in the annular space 34. Therefore, it is possible to obtain action and effects similar to those of the above-described embodiment.

Furthermore, the thermal conductivity can be substantially lowered in comparison with air and nitrogen also in a case where one of the following gases is filled in the annular space 34: a gas in which the xenon gas and helium gas (whose thermal conductivity at 800° C. is approximately 0.37 (W/m·K)) are mixed at a ratio of 100%:0% to 90%:10%, a gas in which the xenon gas and neon gas (whose thermal conductivity at 800° C. is approximately 0.11 (W/m·K)) are mixed at a ratio of 100%:0% to 60%:40%, a gas in which the krypton gas and the neon gas are mixed at a ratio of 100%:0% to 70%:30%, and a gas in which the argon gas and the neon gas are mixed at a ratio of 100%:0% to 80%:20%. Therefore, it is possible to obtain action and effects similar to those of the above-described embodiment.

What is claimed:

1. A discharge bulb comprising:
an arc tube having a light-emitting tube portion; and
a shroud glass surrounding said arc tube in a tubular form,
wherein an inert gas and a metal halide are contained in a discharge space inside said light-emitting tube portion, the discharge space being mercury-free; and
a gas having lower thermal conductivity than air is contained in an annular space defined between said arc tube and said shroud glass.

2. The discharge bulb according to claim 1, wherein the gas contained in the annular space between the tube and the shroud glass contains not less than 50% in total of one or more of argon gas, krypton gas, and xenon gas.

3. The discharge bulb according to claim 1, wherein the gas contained in the annular space contains not less than 60% xenon gas.

4. The discharge bulb according to claim 2, wherein the gas contained in the annular space contains not less than 60% xenon gas.

5. The discharge bulb according to claim 1, wherein a charging pressure of the gas in the annular space is 0.2 to 0.9 atm.

6. The discharge bulb according to claim 2, wherein a charging pressure of the gas in the annular space is 0.2 to 0.9 atm.

7. The discharge bulb according to claim 3, wherein a charging pressure of the gas in the annular space is 0.2 to 0.9 atm.
